(19) United States
(12) Patent Application Publication
(10) Pub. No.: US 2007/0169711 A1
(43) Pub. Date: Jul. 26, 2007

(54) HARVEST CONE FOR SEA CAGE FOR FISH-GROWING

(76) Inventor: Neil A. SIMS, Kona, HI (US)

Correspondence Address: Leighton K. Chong;Godbey Griffiths Reiss & Chong, Pauahi Tower, 1001 Bishop Street, Suite 2300, Honolulu, HI, 96813, US

(21) Appl. No.: 11/627,351

(22) Filed: Jan. 25, 2007

Related U.S. Application Data
(60) Provisional application No. 60/762,403, filed on Jan. 25, 2006.

(51) Int. Cl. A01K 61/00

(52) U.S. Cl. 119/223

(57) ABSTRACT

An internal net in an inverted cone shape is provided inside a fish-growing cage of the type having a central spar for deploying surrounding outside cage netting attached thereto. The internal net has netting with an open mouth suspended between a higher point on the outer netting of the cage and an apex of the netting attached to a lower point on the central spar. The fish become concentrated in the internal net when the cage is raised from a normal, submerged position to at least a partly emergent position from the water, thereby allowing the fish to be harvested from the apex with a harvest pipe or for or other management operations, such as grading or bath treating.

This U.S. patent application claims the priority filing date of U.S. Provisional Application 60/762,403 filed on Jan. 25, 2006, of the same title, by the same inventors.

### BACKGROUND OF INVENTION

Large, sea or ocean-deployed cages have been developed for growing fish in contained environments in sea or ocean waters, such as the Sea Station™ cages made by Ocean Spar, LLC, of Bainbridge Island, Wash. This type of cage typically has a central vertical spar or chamber of controllable buoyancy that is tethered at its lower end to an anchor (or anchors) or grid mooring system on the sea floor, and is used to deploy netting extending on all sides of the central spar to outer netting forming the outer boundaries for the cages.

However, the Sea Station™ and other such cages lack a functional system for corralling or harvesting the fish. Farming operations using Sea Station™ cages have to devise their own harvest system. One farming operation has used a fish-trap device and suction hose around the rim of the cage to harvest the fish. Often, divers are used to corral the fish, but this can be very dangerous with strong-swimming or aggressive animals. Other proposals include lowering the top half of the net, or raising the bottom half of the net, in order to crowd the fish and thereby harvest them at higher densities. However, these proposals have not proved to be practical.

### SUMMARY OF INVENTION

In accordance with the present invention, an improvement in a fish-growing cage of the type having a central spar for deploying surrounding cage netting attached thereto comprises an internal net of netting material having an open mouth suspended between a higher point on the outer netting of the cage and an apex attached to a lower point on the central spar, for concentrating fish in the internal net when the cage is raised from a normal, submerged position to at least a partly emergent position from the water. The fish become trapped inside the internal net become increasingly concentrated or crowded at the lower apex where they can be pumped out of the cage with a harvest pipe or hose for harvesting or other management operations, such as grading or bath treating.

Other objects, features, and advantages of the present invention will be explained in the following detailed description of the invention having reference to the appended drawing.

### BRIEF DESCRIPTION OF DRAWINGS

FIG. 1 illustrates the improvement in accordance with the invention in which an internal net in an inverted cone shape is positioned inside a fish-growing cage for concentrating fish for harvesting.

### DETAILED DESCRIPTION OF INVENTION

In the following description, a preferred embodiment of the invention is described in an example using a fish-growing cage of the type having a central spar or other buoyancy chamber for deploying the netting, such as the Sea Station™ cage made by Ocean Spar, LLC, of Bainbridge Island, Wash. A person skilled in the art will realize that other embodiments of the invention are possible and that the details of the invention can be modified in a number of respects, all without departing from the inventive concept. Thus, the following description and drawings referenced herein are to be regarded as illustrative in nature and not restrictive of the invention.

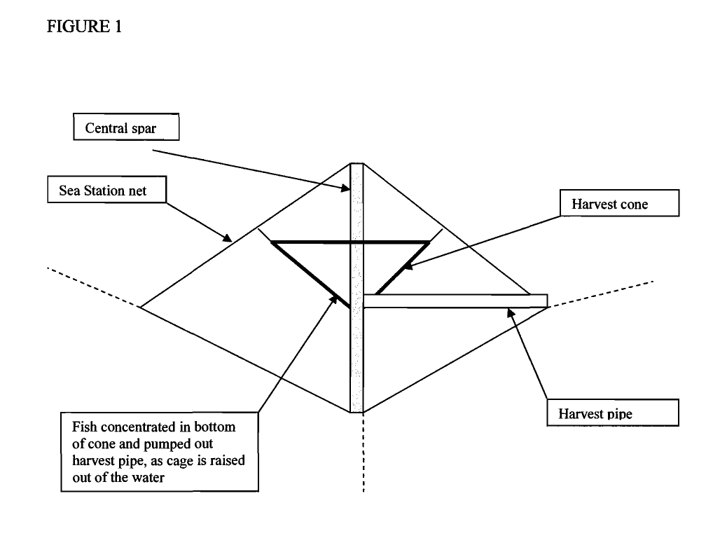

In FIG. 1, a preferred embodiment of the invention is shown in which an internal net is positioned inside a fish-growing cage in the shape of an inverted cone set in the top half of the cage. A gap in the netting is left between the upper edges of the open mouth of the harvest cone and the outside netting of the cage, to allow ingress of the fish and divers to the inside of the cone. At a number of points around the upper edges of the harvest cone, the harvest cone net is suspended from the spoke lines or outer net webbing by lines that are clipped or otherwise attached (by hoops or knots) to the spoke lines or the net webbing. The apex (bottom) of the harvest cone is affixed to the central spar close to the cage equator, where the internal net converges around the central spar. The harvest cone apex may be attached to the central spar with an apex fastener made of hard plastic or other firm material, and has an attachment point for the hose used to pump the fish out of the cage. The apex fastener is affixed to the spar or other attachment point by means of lines, lashing or clamps around the spar. These attachments may be loosened to allow the harvest cone apex to be raised or lowered, as desired, either by divers in the water or by lines and pulley systems attached to hydraulic or other pulling devices on an attendant vessel, or to better effect the crowding and pumping of the fish.

These attachments of the netting and apex of the harvest cone allow the cone to maintain its shape as the cage is raised out of the water. A harvest pipe or other means of pumping fish from the apex of the harvest cone communicates to the outside of the cage. This hose may be permanently fused or otherwise attached to the apex fastener, using clamps, lashing, or other standard hose connectors, or else it may be introduced through the side of the cage when and as needed by divers, and then temporarily attached to the apex fastener. In the latter instance, the hose can be removed when the harvest cone is not being used.

As the cage is raised to the partially emergent position, the fish become trapped inside the harvest cone. Additional fish can also be lured into the harvest cone by providing feed as the cage is being raised, or by other inducements or attractants, or by design of the harvest cone net shape with addition of lips, panels, or other webbing surfaces which facilitate fish ingress but inhibit fish egress, much like a Polynesian fish weir or other form of fish trap. The fish then become increasingly concentrated as the cone becomes more emergent. At some point, the fish are sufficiently concentrated that they can be pumped out of the bottom of the cone through the pipe or other means provided. Once sufficient fish have been pumped, the cone can be lowered back into the water, allowing fish to again move back and forth into and out of the cone.

When the harvest cone is not being used (in between harvests), a zipper in the side of the cone can be opened, or one or more sections of the cone can be unstitched, to allow easier movement of fish into and out of the cone, and to prevent them being inadvertently trapped. The zipper may be sewn into the harvest cone webbing, or the sections of cone may be laced together with a line, or other various means of attaching two pieces of net webbing together.

An additional variation is to place a cone-shaped entry through the wall of the harvest cone. This will act along the lines of a fish weir, allowing fish to move into the harvest cone, but not allowing the fish to move back to the outside of the harvest cone.

It is to be understood that many modifications and variations may be devised given the above description of the principles of the invention. It is intended that all such modifications and variations be considered as within the spirit and scope of this invention, as defined in the following claims.

1. An improvement in a fish-growing cage of the type having a central spar for deploying surrounding outside cage netting attached thereto, wherein the improvement comprises: an internal net of netting material having an open mouth suspended between a higher point on the outer netting of the cage and an apex attached to a lower point on the central spar, for concentrating fish in the internal net when the cage is raised from a normal, submerged position to at least a partly emergent position from the water.

2. An improvement in a fish-growing cage according to claim 1, wherein the internal net is in the shape of an inverted cone set in a top half of the cage.

3. An improvement in a fish-growing cage according to claim 1, wherein the open mouth of the internal net has a gap provided between upper edges of its netting and the outside netting of the cage, to allow ingress of the fish in the cage to the inside of the internal net.

4. An improvement in a fish-growing cage according to claim 3, wherein the open mouth of the internal net is suspended at a number of points around its upper edges from spoke lines or outer net webbing to the outside netting of the cage.

5. An improvement in a fish-growing cage according to claim 1, wherein the apex of the internal net is attached by an apex fastener to the central spar.

6. An improvement in a fish-growing cage according to claim 5, wherein the apex fastener can be unfastened from the central spar to allow the apex of the internal net to be raised or lowered on the central spar to any desired position.

7. An improvement in a fish-growing cage according to claim 5, wherein the apex fastener has an attachment for an input end of a harvest pipe or hose for harvesting fish from the apex of the internal net.

8. An improved method of harvesting fish from a fish-growing cage of the type having a central spar for deploying surrounding outside cage netting attached thereto, wherein the improvement comprises: providing an internal net of netting material having an open mouth suspended between a higher point on the outer netting of the cage and an apex of the netting attached to a lower point on the central spar, and raising the cage from a normal, submerged position to at least a partly emergent position from the water in order to concentrate fish in the internal net when the cage is raised.

9. An improved method of harvesting fish from a fish-growing cage according to claim 8, further comprising providing an input end of a harvest pipe or hose in the vicinity of the apex of the internal net for harvesting fish therefrom.

10. An improved method of harvesting fish from a fish-growing cage according to claim 9, wherein the fish are removed from the internal net to an external location for harvesting or other management operations, such as grading or bath treating.
